(19) United States
(12) Patent Application Publication
(10) Pub. No.: US 2023/0420184 A1
(43) Pub. Date: Dec. 28, 2023

(54) COIL COMPONENT AND MANUFACTURING METHOD THEREFOR

(71) Applicant: TDK Corporation, Tokyo (JP)

(72) Inventors: Yuuichi KAWAGUCHI, Tokyo (JP); Naoaki FUJII, Tokyo (JP); Tomonaga NISHIKAWA, Tokyo (JP); Liyi CHEN, Tokyo (JP); Rui SAKUMA, Tokyo (JP)

(21) Appl. No.: 18/330,628

(22) Filed: Jun. 7, 2023

(30) Foreign Application Priority Data
Jun. 24, 2022 (JP) 2022-101693

(51) Int. Cl. H01F 41/04; H01F 27/32; H01F 17/00

(52) U.S. Cl. CPC H01F 41/041; H01F 27/327; H01F 17/0013

(57) ABSTRACT

Disclosed herein is a coil component that includes an element body having a mounting surface, a coil part embedded in the element body, and a first conductor post embedded in the element body. The first conductor post has a first end connected to the coil part and a second end exposed from the mounting surface. A surface of the element body on the mounting surface side has a recess from a surface of the first conductor post.

### BACKGROUND OF THE ART

### Field of the Art

The present disclosure relates to a coil component and a manufacturing method therefor and, more particularly, to a coil component having a structure in which a coil part is embedded in a magnetic element body and a manufacturing method for such a coil component.

### Description of Related Art

JP 2021-052076A discloses a coil component having a structure in which a coil part is embedded in a magnetic element body. According to the technology disclosed in JP 2021-052076A, with the use of a magnetic element body as an element for embedding therein a coil part, a small coil component having high inductance can be provided.

However, the coil component described in JP 2021-052076A has a flat mounting surface from which a conductor post is exposed, so that when it is mounted on a circuit board, an underfill material or the like hardly enters between the mounting surface of the coil component and the circuit board.

### SUMMARY

It is therefore an object of the present disclosure to provide a coil component having a structure in which an underfill material easily enters between the mounting surface of the coil component and a circuit board on which the coil component is mounted and a manufacturing method for such a coil component.

A coil component according to the present disclosure includes an element body having a mounting surface, a coil part embedded in the element body, and a conductor post which is embedded in the element body, one end of which is connected to the coil part, and the other end of which is exposed from the mounting surface. The surface of the element body on the mounting surface side has a recess from the surface of the conductor post.

A manufacturing method for the coil component according to the present disclosure includes: a step of forming a coil part; a step of forming, on one side in the coil axis direction of the coil part, a conductor post whose one end is connected to the coil part; a step of forming an element body on the one side in the coil axis direction of the coil part and in the inner diameter area of the coil part so as to embed therein the coil part and conductor post; a step of grinding the surface of the element body so as to expose the other end of the conductor post therefrom; and a step of applying pressure to the element body such that the surface of the element body is recessed from the surface of the conductor post.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic plan view of a coil component 1 according to a first embodiment of the present disclosure as viewed from a mounting surface side of the coil component 1;

FIG. 2 is a schematic cross-sectional view taken along the line A-A in FIG. 1;

FIG. 3 is a schematic cross-sectional view illustrating a state where the coil component 1 is mounted on a circuit board 80;

FIGS. 4 to 17 are process views for explaining the manufacturing method for the coil component 1;

FIG. 18 is a schematic plan view of a coil component 1A according to a first modification;

FIG. 19 is a schematic plan view of a coil component 1B according to a second modification;

FIG. 20 is a schematic cross-sectional view illustrating the configuration of a coil component 2 according to a second embodiment of the present disclosure; and

FIG. 21 is a schematic cross-sectional view illustrating the configuration of a coil component 3 according to a third embodiment of the present disclosure.

### DETAILED DESCRIPTION OF THE EMBODIMENTS

Preferred embodiments of the present disclosure will be explained below in detail with reference to the accompanying drawings.

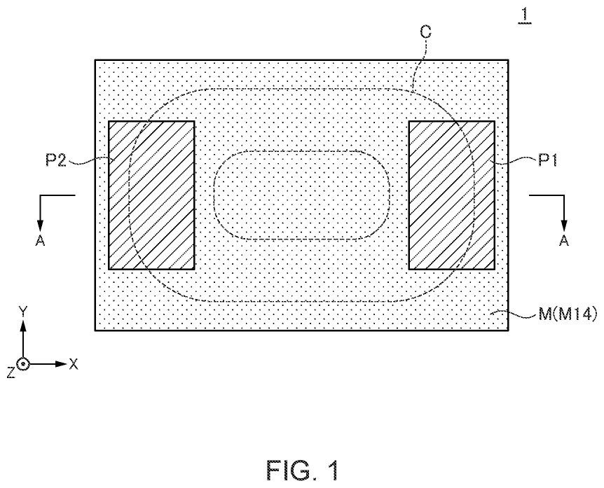

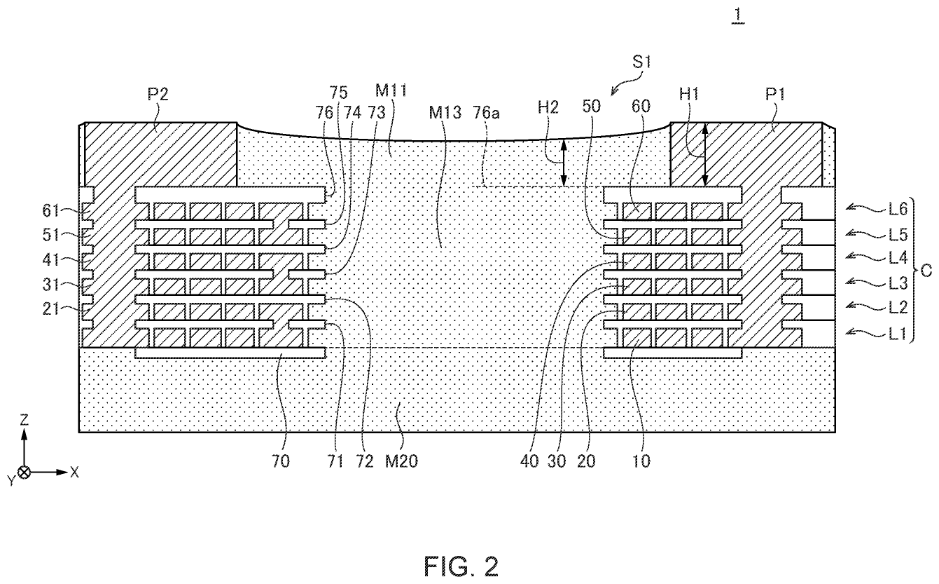

FIG. 1 is a schematic plan view of a coil component 1 according to a first embodiment of the present disclosure as viewed from a mounting surface side of the coil component 1. FIG. 2 is a schematic cross-sectional view taken along the line A-A in FIG. 1.

As illustrated in FIGS. 1 and 2, the coil component 1 according to the present embodiment has a structure in which a coil part C having a coil axis extending in the Z-direction is embedded in a magnetic element body M. The magnetic element body M includes a region M11 covering the coil part C from the positive Z-direction side, a region M20 covering the coil part C from the negative Z-direction, a region M13 connecting the regions M11 and M20, and a region M14 positioned in the outside area of the coil part C. Conductor posts P1 and P2 are embedded in the region M11 of the magnetic element body M.

The coil part C includes interlayer insulating films 70 to 76 and conductor layers L1 to L6 which are alternately stacked in the coil axis direction. The conductor layers L1 to L6 have coil patterns 10, 20, 30, 40, 50, and 60, respectively. The coil patterns 10, 20, 30, 40, 50, and 60 are connected in series to constitute a single coil. One end of the coil is connected to one end (lower end) of the conductor post P1, and the other end thereof is connected to one end (lower end) of the conductor post P2. In the example illustrated in FIG. 2, the outer peripheral end of the coil pattern 60 positioned in the uppermost layer is connected to the conductor post P1, and the outer peripheral end of the coil pattern 10 positioned in the lowermost layer is connected to the conductor post P2 through connection patterns 21, 31, 41, 51, and 61. Other ends (upper ends) of the conductor posts P1 and P2 are exposed from a mounting surface S1. The conductor posts P1 and P2 are conductors that overlap the coil part C as viewed in the coil axis direction and extend in the coil axis direction.

The magnetic element body M is a composite magnetic member containing magnetic metal filler made of iron (Fe) or a permalloy-based material and a resin binder and forms a magnetic path for magnetic flux generated by making a current flow in the coil patterns 10, 20, 30, 40, 50, and 60. The resin binder is preferably epoxy resin of liquid or powder. The magnetic metal filler may be a mixture of a plurality of magnetic metal fillers having different mean particle diameters. This facilitates adjustment of permeability and flowability of the magnetic element body M. The flowability adjustment is important in a to-be-described recess formation process using water pressure or the like.

As illustrated in FIG. 2, the surface of the magnetic element body M on the mounting surface S1 side is recessed from the surfaces of the conductor posts P1 and P2. That is, when a surface 76a of the interlayer insulating film 76 constituting the surface of the coil part C on one side in the coil axis direction is used as a reference, the conductor posts P1 and P2 have a height of H1, while the magnetic element body M has a height of H2 (<H1). It follows that the conductor posts P1 and P2 slightly protrude from the mounting surface S1, while the magnetic element body M is slightly recessed therefrom. The recess of the magnetic element body M becomes deeper from the conductor posts P1 and P2 toward the center axis of the coil part C. More specifically, the height H2 of the magnetic element body M is almost the same as the height H1 of the conductor posts P1 and P2 at portions adjacent to the conductor posts P1 and P2, while the height H2 of the magnetic element body M decreases as the distance from the conductor posts P1 and P2 increases. The recess of the magnetic element body M becomes deepest at a position overlapping the inner diameter area of the coil part C.

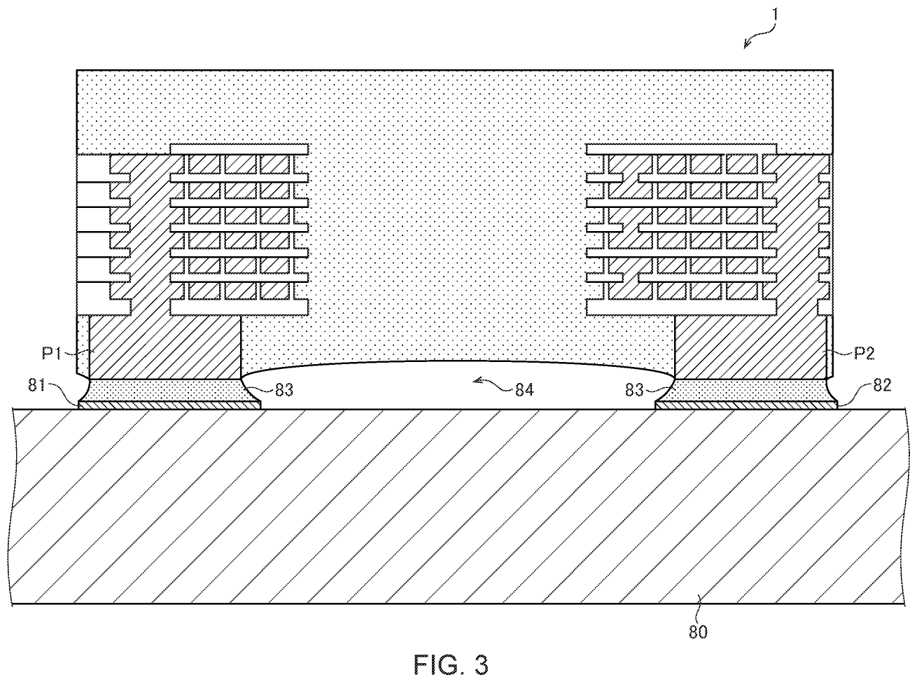

FIG. 3 is a schematic cross-sectional view illustrating a state where the coil component 1 is mounted on a circuit board 80.

The circuit board 80 illustrated in FIG. 3 has land patterns 81 and 82, and the coil component 1 is mounted on the circuit board 80 such that the conductor posts P1 and P2 are connected respectively to the land patterns 81 and 82 through a solder 83. In the coil component 1 according to the present embodiment, the mounting surface S1 has the recess, so that when the coil component 1 is mounted on the circuit board 80, a space 84 is formed between the circuit board 80 and the mounting surface S1 of the coil component 1. The height of the space 84 increases by a value obtained by H1−H2 as compared to when the magnetic element body M is not recessed, allowing an underfill material or mold resin to easily enter between the mounting surface S1 of the coil component 1 and the circuit board This improves mounting reliability of the coil component 1.

The ratio (=H2/H1) between the heights H1 and H2 is preferably 50% or more and 90% or less. When the ratio between the heights H1 and H2 is less than 50%, a reduction in inductance due to a reduction in volume of the magnetic element body M cannot be ignored; on the other hand, when the ratio between the heights H1 and H2 exceeds 90%, a mounting reliability improving effect is insufficient.

The following describes a manufacturing method for the coil component 1 according to the present embodiment.

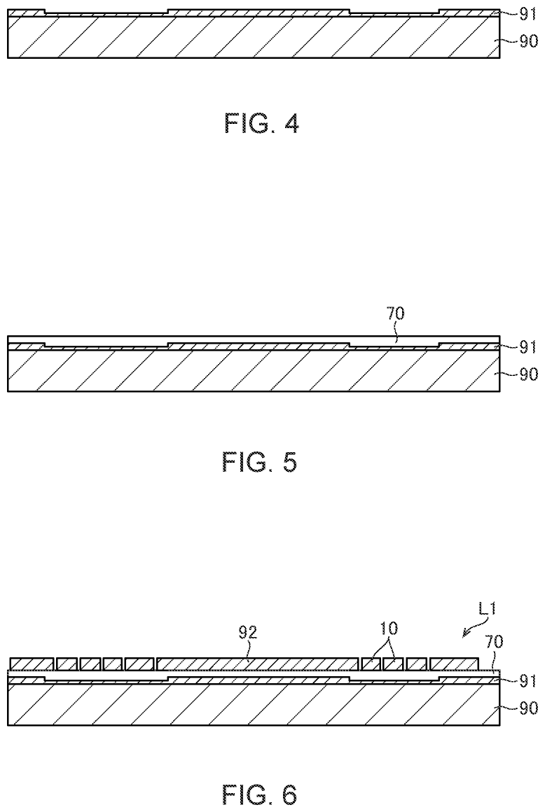

FIGS. 4 to 17 are process views for explaining the manufacturing method for the coil component 1 according to the present embodiment.

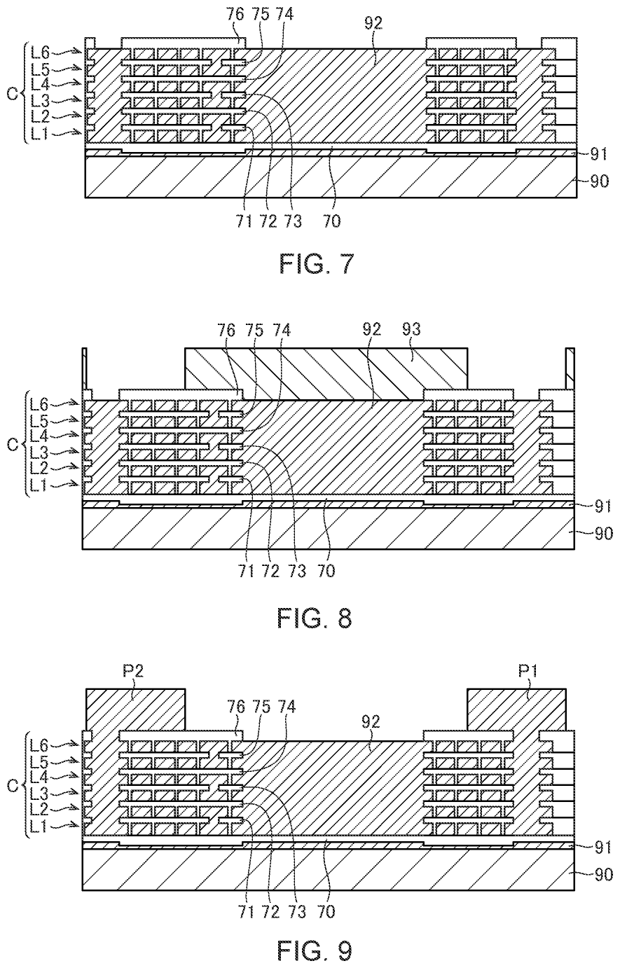

A base material having a copper foil 91 on the surface of a support 90 is prepared and subjected to etching or the like to selectively reduce the film thickness of the copper foil 91 at a position overlapping the coil part C (FIG. 4). Then, the surface of the copper foil 91 is covered with the interlayer insulating film 70 (FIG. 5), and the conductor layer L1 is formed on the surface of the interlayer insulating film 70 (FIG. 6). At this time point, as illustrated in FIG. 6, the conductor layer L1 includes a sacrificial pattern 92. Then, the processes illustrated in FIGS. 5 and 6 are repeated to form the coil part C (FIG. 7). The sacrificial patterns 92 included in the respective conductor layers L1 to L6 are not separated by the interlayer insulating films 71 to 75 but contact each other.

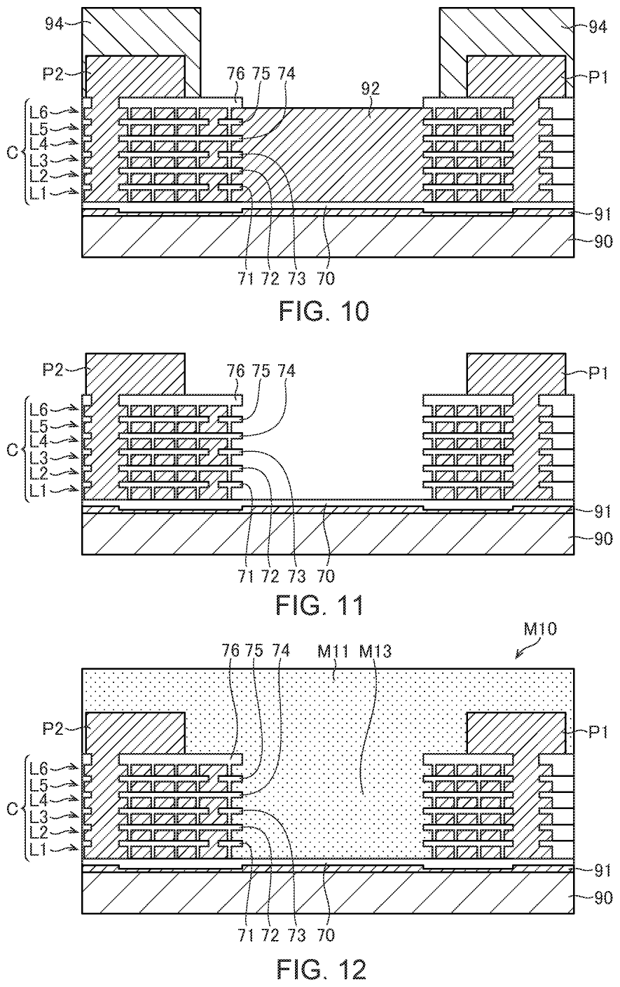

Then, a resist 93 is formed (FIG. 8), followed by electrolytic plating to form the conductor posts P1 and P2 (FIG. 9). As a result, the conductor posts P1 and P2 are provided on one side in the coil axis direction of the coil part C. Then, the conductor posts P1 and P2 are covered with a resist 94 (FIG. 10), and the sacrificial patterns 92 are removed by etching using acid or the like, by laser processing, or other methods (FIG. 11). As a result, the inner diameter area of the coil part C becomes a cavity. The sacrificial pattern 92 is also formed in the outside area of the coil part C (although not illustrated), and by removing this sacrificial pattern 92, the outside area of the coil part C also becomes a cavity.

Then, a magnetic element body M10 having flowability is formed on one side in the coil axis direction of the coil part C, in the inner diameter area of the coil part C, and in the outside area of the coil part C so as to embed therein the coil part C and conductor posts P1 and P2 (FIG. 12). Although the magnetic element body M10 has the region M11 positioned on one side in the coil axis direction of the coil part C, the region M13 positioned in the inner diameter area of the coil part C, and the region M14 positioned in the outside area of the coil part C, only the regions M11 and M13 appear in the cross section illustrated in FIG. 12.

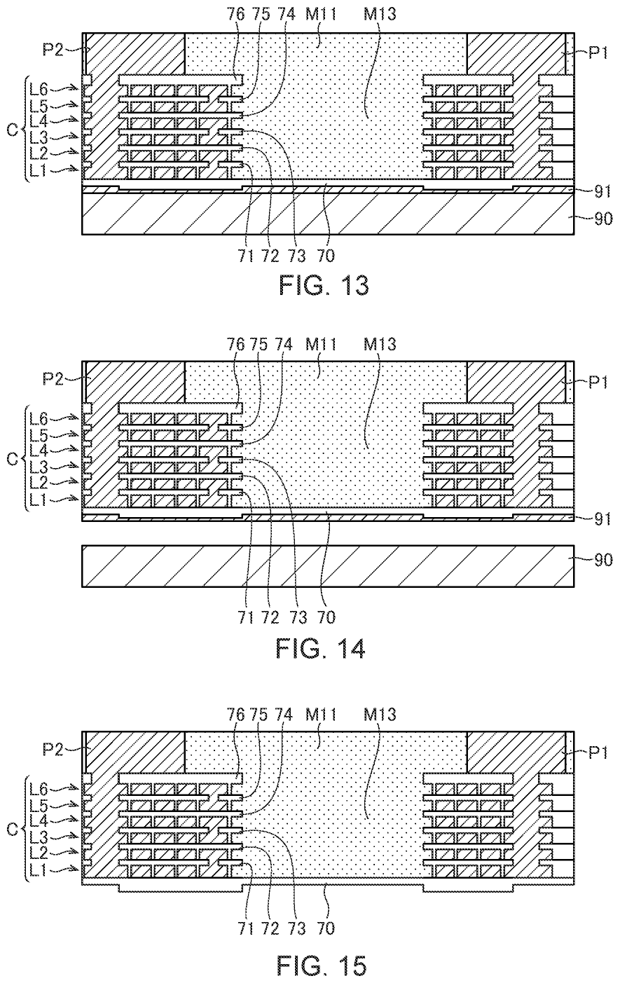

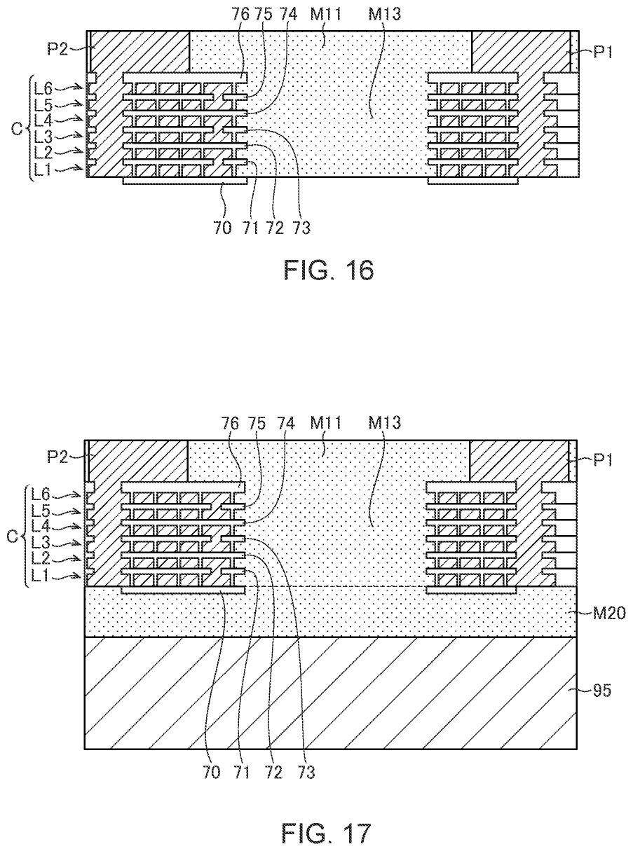

Then, the magnetic element body M10 is temporarily cured, and the surface thereof is ground to expose the surfaces of the conductor posts P1 and P2 (FIG. 13). Thus, at this time point, the surface of the magnetic element body M10 and the surfaces of the conductor posts P1 and P2 are flush with one another. Then, the support 90 is peeled off (FIG. 14), followed by removal of the copper foil 91 by etching to expose the interlayer insulating film 70 (FIG. 15). Subsequently, the interlayer insulating film 70 is subjected to desmear treatment to reduce the film thickness of the interlayer insulating film 70. As a result, the regions M13 and M14 of the magnetic element body M10 positioned in the inner diameter area and outside area of the coil part C are exposed (FIG. 16).

Then, an already cured magnetic element body M20 is formed on the other side in the coil axis direction of the coil part C (FIG. 17). As a result, the coil part C is sandwiched by the region M11 of the magnetic element body M10 and the magnetic element body M20 in the axis direction, and the magnetic element bodies M10 and M20 are magnetically connected through the regions M13 and M14. Subsequently, in a state where a plate 95 is stuck to the magnetic element body M20 so as to cover the same, the magnetic element body M10 is pressurized by water pressure or the like to cure the temporarily cured magnetic element body M10. Thus, pressure is applied to the region M11 of the temporarily cured magnetic element body M10, with the result that, as illustrated in FIG. 2, the surface of the magnetic element body M11 is recessed from the surfaces of the conductor posts P1 and P2. The magnetic element body M20, which has already been cured and fixed to the plate has almost no deformation. After that, the magnetic element body M is completely cured and singulated, whereby the coil component 1 according to the present embodiment is obtained.

As described above, in the present embodiment, the temporarily cured magnetic element body M11 is pressurized for deformation by water pressure or the like without providing a plate or the like on the magnetic element body M11 side. Thus, without use of a dedicated die or the like, it is possible to form a recess in the surface of the magnetic element body M11 positioned on the mounting surface S1 side from which the conductor posts P1 and P2 are exposed.

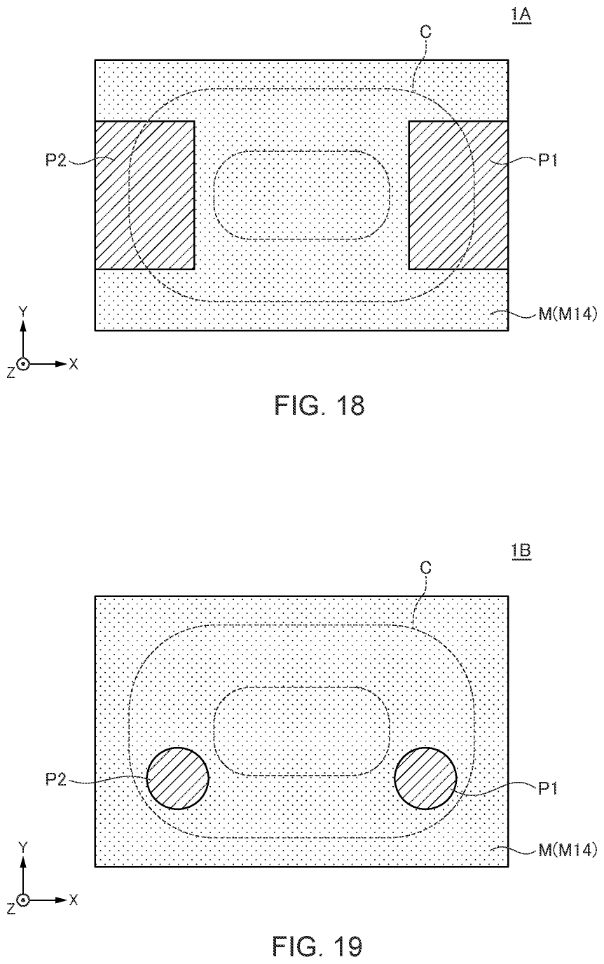

Like a coil component 1A according to a first modification illustrated in FIG. 18, the conductor posts P1 and P2 may each be exposed not only from the mounting surface S1 but also from the YZ surface. With this configuration, when the coil component 1A is mounted on the circuit board 80, the fillet of the solder 83 can be formed on the YZ surface. Further, the planar shape of a part of each of the conductor posts P1 and P2 that is exposed to the mounting surface S1 need not be rectangular but may be circular like a coil component 1B according to a second modification illustrated in FIG. 19.

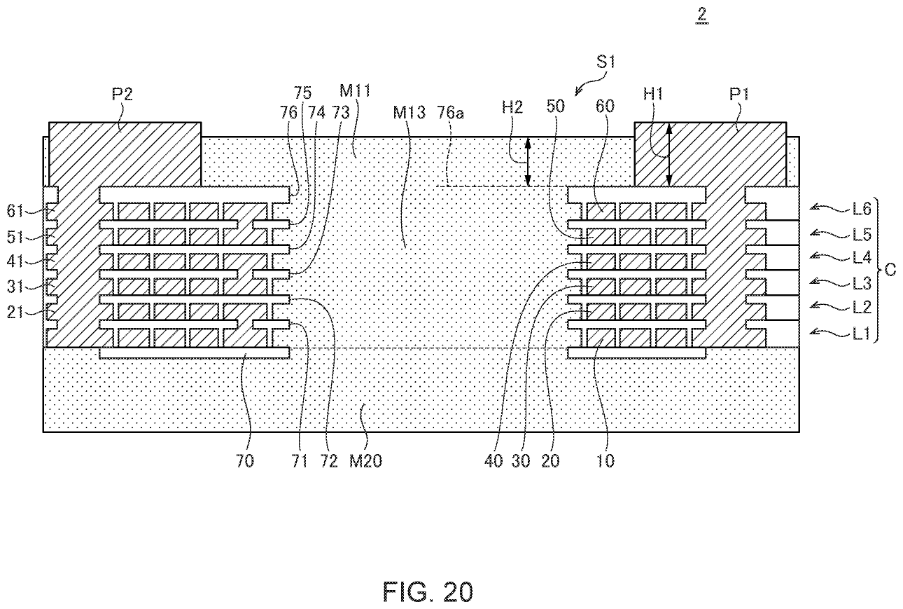

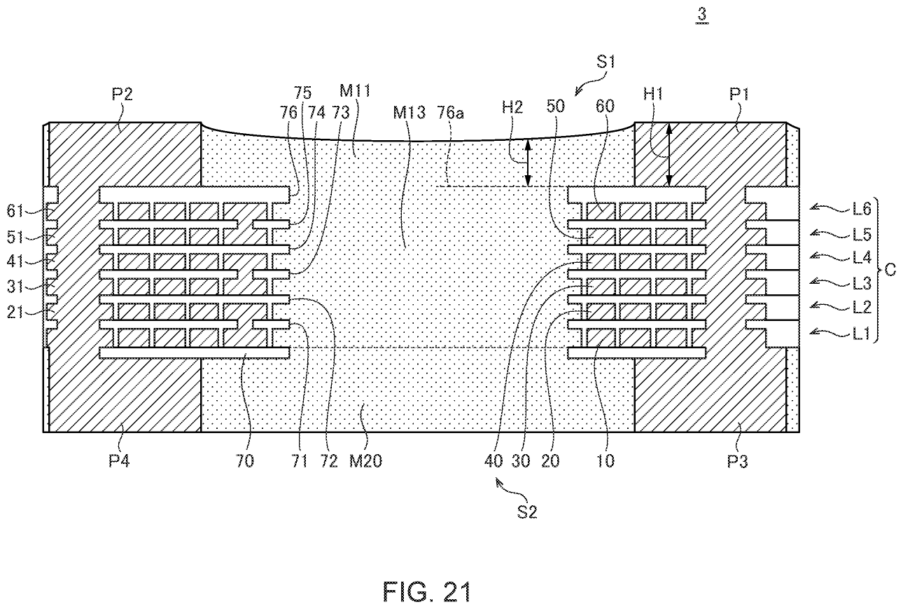

FIG. 20 is a schematic cross-sectional view illustrating the configuration of a coil component 2 according to a second embodiment of the present disclosure.

As illustrated in FIG. 20, the coil component 2 according to the second embodiment differs from the coil component 1 according to the first embodiment in that the surface of the magnetic element body M on the mounting surface S1 side is not curved but is entirely recessed from the surfaces of the conductor posts P1 and P2. That is, the height H2 is almost constant. Other basic configurations are the same as those of the coil component 1 according to the first embodiment, so the same reference numerals are given to the same elements, and overlapping description will be omitted. As exemplified by the present embodiment, the surface of the magnetic element body M on the mounting surface S1 side may not necessarily be curved but may be almost flat.

FIG. 21 is a schematic cross-sectional view illustrating the configuration of a coil component 3 according to a third embodiment of the present disclosure.

As illustrated in FIG. 21, the coil component 3 according to the third embodiment differs from the coil component 1 according to the first embodiment in that it further has conductor posts P3 and P4. Other basic configurations are the same as those of the coil component 1 according to the first embodiment, so the same reference numerals are given to the same elements, and overlapping description will be omitted. The conductor posts P3 and P4 are embedded in the magnetic element body M20 and are short-circuited respectively to the conductor posts P1 and P2. More specifically, one end of the conductor post P3 is connected to the outer peripheral end of the coil pattern 60 like the conductor post P1, and one end of the conductor post P4 is connected to the outer peripheral end of the coil pattern 10 like the conductor posts P2. The other ends of the conductor posts P3 and P4 are exposed to a surface S2 on the opposite side of the mounting surface S1. Adding such configured conductor posts P3 and P4 allows connection from both sides in the coil axis direction, which is suitable when the coil component 3 is used by being embedded in a multilayer substrate.

While the preferred embodiment of the present disclosure has been described, the present disclosure is not limited to the above embodiment, and various modifications may be made within the scope of the present disclosure, and all such modifications are included in the present disclosure.

For example, the configuration of the coil part C is not limited to that described in the above embodiments, and two coils may be alternately stacked through an interlayer insulating film to constitute a common mode filter.

Further, although the coil part C is embedded in the magnetic element body M in the above embodiments, the use of the magnetic element body is not essential in the present disclosure, and a nonmagnetic element body may be used.

The technology according to the present disclosure includes the following configuration examples but not limited thereto.

A coil component according to the present disclosure includes an element body having a mounting surface, a coil part embedded in the element body, and a conductor post which is embedded in the element body, one end of which is connected to the coil part, and the other end of which is exposed from the mounting surface. The surface of the element body on the mounting surface side has a recess from the surface of the conductor post.

According to the present disclosure, the surface of the element body on the mounting surface side has a recess, so that, when the coil component is mounted on a circuit board, an underfill material easily enters between the mounting surface of the coil component and the circuit board. This can improve mounting reliability.

In the present disclosure, the recess may become deeper from the conductor post toward the center axis of the coil part. This can improve mounting reliability while ensuring a sufficient volume of the element body.

In the present disclosure, the recess may become deepest at a position overlapping the inner diameter area of the coil part. This allows a sufficient amount of an underfill material to be introduced to the position overlapping the inner diameter area of the coil part.

The coil component according to the present disclosure may further has another conductor post which is embedded in the element body, one end of which is connected to the coil part, and the other end of which is exposed to the surface on the opposite side of the mounting surface. This allows connection from both sides in the coil axis direction.

A manufacturing method for the coil component according to the present disclosure includes: a step of forming a coil part; a step of forming, on one side in the coil axis direction of the coil part, a conductor post whose one end is connected to the coil part; a step of forming an element body on the one side in the coil axis direction of the coil part and in the inner diameter area of the coil part so as to embed therein the coil part and conductor post; a step of grinding the surface of the element body so as to expose the other end of the conductor post therefrom; and a step of applying pressure to the element body such that the surface of the element body is recessed from the surface of the conductor post.

According to the present disclosure, it is possible to form a recess in the surface of the element body on the mounting surface side with a simple method.

As described above, according to the present disclosure, there can be provided a coil component having a structure in which an underfill material easily enters between the mounting surface of the coil component and the circuit board on which the coil component is mounted and a manufacturing method for such a coil component.

What is claimed is:

1. A coil component comprising:
an element body having a mounting surface;
a coil part embedded in the element body; and
a first conductor post embedded in the element body,
wherein the first conductor post has a first end connected to the coil part and a second end exposed from the mounting surface, and
wherein a surface of the element body on the mounting surface side has a recess from a surface of the first conductor post.

2. The coil component as claimed in claim 1, wherein the recess becomes deeper from the first conductor post toward a center axis of the coil part.

3. The coil component as claimed in claim 2, wherein the recess becomes deepest at a position overlapping an inner diameter area of the coil part.

4. The coil component as claimed in claim 1, further comprising a second conductor post embedded in the element body,
wherein the second conductor post has a third end connected to the coil part and a fourth end exposed to a surface on an opposite side of the mounting surface.

5. The coil component as claimed in claim 1, wherein the element body has a magnetic property.

6. A method for manufacturing a coil component, the method comprising:
forming a coil part;
forming, on one side in a coil axis direction of the coil part, a conductor post whose one end is connected to the coil part;
forming an element body on the one side in the coil axis direction of the coil part and in an inner diameter area of the coil part so as to embed therein the coil part and conductor post;
grinding a surface of the element body so as to expose other end of the conductor post therefrom; and
applying pressure to the element body such that a surface of the element body is recessed from a surface of the conductor post.
